(19) United States
(12) Patent Application Publication
(10) Pub. No.: US 2015/0212759 A1
(43) Pub. Date: Jul. 30, 2015

(54) STORAGE DEVICE WITH MULTIPLE PROCESSING UNITS AND DATA PROCESSING METHOD

(71) Applicant: SAMSUNG ELECTRONICS CO., LTD., SUWON-SI (KR)

(72) Inventor: MYUNG-HYUN JO, HWASEONG-SI (KR)

(21) Appl. No.: 14/447,668

(22) Filed: Jul. 31, 2014

(30) Foreign Application Priority Data
Jan. 29, 2014 (KR) 10-2014-0011502

(51) Int. Cl. G06F 3/06; G06F 13/28

(52) U.S. Cl. CPC G06F 3/0659; G06F 13/28; G06F 3/0604; G06F 3/0679; G06F 2003/0697

(57) ABSTRACT

A storage device includes; a nonvolatile memory, a command division unit that divides a received command into unit commands and distributes the multiple unit commands across multiple processing units. Respective data processing preparation units receive different unit commands and generate corresponding DMA requests. The multiple processing units are operationally associated with DMA request queues, and the nonvolatile memory executes a first data access operation in response to the first DMA requests, and a second data access operation in response to the second DMA requests.

### CROSS-REFERENCE TO RELATED APPLICATION

This application claims priority under 35 U.S.C. 119 from Korean Patent Application No. 10-2014-0011502 filed on Jan. 29, 2014, the subject matter of which is hereby incorporated by reference.

### BACKGROUND

The present inventive concept relates generally to storage devices and methods of processing data in a storage device.

The execution time of firmware running on processing unit of a storage device (e.g., a central processing unit (CPU)) can markedly affect the input/output performance of the storage device. For example, data access operations (e.g., read and write operations) executed in the storage device may be performed using direct memory access (DMA). The firmware controlling the execution of DMA requests may involve the preparation, initiation and completion of various DMA operations. In order to achieve a high speed operation of the storage device, it is necessary to reduce the overall execution time (and commensurate consumption of resources) of the firmware.

Multi-processing unit architectures or a multi-core architectures may be employed as the processing unit of the storage to secure performance of the storage. In such cases, it is necessary to provide a method for maintaining consistency of data input/output by different processing units. In order to maintain data consistency, when one among multiple processing units constituting the storage is used as a locking manager, there may be a problem of consumption in resources of the processing units.

Korean Patent Publication No. 2012-0004087 discloses a lock-free memory controller for a multi-processor and a multi-processor system using the lock-free memory controller.

### SUMMARY

Embodiments of the inventive concept provide a storage device exhibiting overall reduced execution times for firmware associated with a multi-processing unit.

In one embodiment, the inventive concept provides a storage device, comprising; a nonvolatile memory, a command parsing unit that receives and verifies a command provided by an external host, a command division unit that receives a verified command from the command parsing unit, divides the command into multiple unit commands, and distributes the multiple unit commands across a first processing unit and a second processing unit, a first data processing preparation unit that receives a first set of the unit commands from the command division unit and generates corresponding first Direct Memory Access (DMA) requests, a second data processing preparation unit that receives a second set of the unit commands from the command division unit and generates corresponding second DMA requests, wherein the first processing unit is operationally associated with a first DMA request queue that receives and holds the first DMA requests generated by the first data processing unit, and the second processing unit is operationally associated with a second DMA request queue that receives and holds the second DMA requests generated by the second data processing unit, and the nonvolatile memory executes a first data access operation in response to the first DMA requests, and executes a second data access operation in response to the second DMA requests.

In another embodiment, the inventive concept provides a storage device, comprising; a nonvolatile memory, a command parsing unit that receives and verifies a command provided by an external host, a command division unit that receives a verified command from the command parsing unit, divides the command into multiple unit commands, and distributes the multiple unit commands across a first processing unit and a second processing unit, a first data processing preparation unit that receives a first set of the unit commands from the command division unit and generates corresponding first Direct Memory Access (DMA) requests, a second data processing preparation unit that receives a second set of the unit commands from the command division unit and generates corresponding second DMA requests, wherein the first processing unit is operationally associated with a first DMA request queue that receives the first DMA requests, and is further operationally associated a first DMA completion queue that receives completion messages upon the respective completion of the first DMA requests, and the second processing unit is operationally associated with a second DMA request queue that receives the second DMA requests, and is further operationally associated a second DMA completion queue that receives completion messages upon the respective completion of the second DMA request, a counting unit that counts a number of the first DMA requests and a number of first DMA operation completion messages related to the first DMA operations, and counts a number of second DMA requests and a number of second DMA operation completion messages related to the second DMA operations, wherein an indication to the host that execution of the command is complete is controlled by the counting unit; and

the nonvolatile memory executes a first data access operation in response to the first DMA requests, and executes a second data access operation in response to the second DMA requests.

In still another embodiment, the inventive concept provides a method of operating a storage device including a first processing unit and a second processing unit each storing data in a flash memory, the storage device receiving a command from a host, and the method, comprising; receiving and verifying the command, upon verifying the command, dividing the command into multiple unit commands, distributing the multiple unit commands across the first and second processing units, generating first Direct Memory Access (DMA) requests in response to a first set of the unit commands, and generating second DMA requests in response to a second set of the unit commands, queuing the first DMA requests for access by the first data processing unit, and queuing the second DMA request for access by the second processing unit, and executing a first data access operation in the flash memory in response to the first DMA requests, and executing a second data access in the flash memory in response to the second DMA requests.

### BRIEF DESCRIPTION OF THE DRAWINGS

The above and other features and advantages of the inventive concept will become more apparent upon consideration of certain embodiments thereof with reference to the accompanying drawings in which:

FIGS. 1 and 2 are respective block diagrams illustrating a storage device according to certain embodiments of the inventive concept;

FIG. 3 is a conceptual diagrams illustrating in one example a command that may be received by the storage device;

FIG. 4 is a conceptual diagram illustrating in another example a command that has been divided by a command division unit;

FIGS. 5 and 6 are related and respective conceptual diagrams illustrating operation of the first and second processing units of FIGS. 1 and 2;

FIG. 7 is a conceptual diagram illustrating one possible configuration for the flash memory of FIGS. 1 and 2;

FIG. 8 is another conceptual diagram illustrating operation of the first and second processing units of FIGS. 1 and 2;

FIG. 9 is a block diagram of a storage device consistent with the inventive concept and implemented as a system-on-chip;

FIG. 10 is a conceptual diagram illustrating in one example a DMA buffer that may be used in certain embodiments of the inventive concept;

FIG. 11, inclusive of FIG. 11A and FIG. 11B, is a flowchart summarizing a data processing method according to certain embodiments of the inventive concept; and

FIGS. 12 and 13 are respective flowcharts summarizing a data processing method according to certain embodiments of the inventive concept.

### DETAILED DESCRIPTION

Certain embodiments of the inventive concept will now be described in some additional detail with reference to the accompanying drawings. The inventive concept may, however, be embodied in many different forms and should not be construed as being limited to only the illustrated embodiments. Rather, these embodiments are provided so that this disclosure will be thorough and complete and will fully convey the concept of the inventive concept to those skilled in the art. Throughout the written description and drawings, like reference numbers and labels are used to denote like or similar elements.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising, ” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

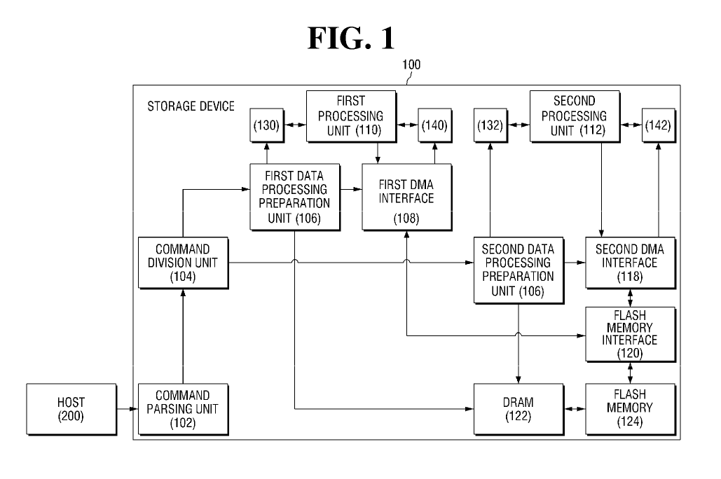

FIG. 1 is a block diagram illustrating a storage device according to certain embodiments of the inventive concept.

Referring to FIG. 1, a storage device 100 is operationally connected to a host 200 and comprises a command parsing unit 102 and a command division unit 104. These two elements combine to control the operation of a first data processing preparation unit 106, a first processing unit 110, a first Direct Memory Access (DMA) interface 108, a first DMA request queue 130, and a first DMA completion queue 140. The command parsing unit 102 and command division unit 104 also operationally combine to control the operation of a second data processing preparation unit 116, and a second processing unit 112, a second DMA interface 118, a second DMA request queue 132, and a second DMA completion queue 142.

In this regard, the command parsing unit 102 may be used to receive, analyze and verify commands received from the host 200. Thereafter, the verified command will be communicated to the command division unit 104. For example, the command parsing unit 102 may be used to analyze address information, data size information, etc., included as part of (or in conjunction with) the received command. If the address data deviates from an expected range of address(es), or if size information deviates from an expected size (or format) for data being stored by the storage device 100, then the command parsing unit 102 may rejected the received command as being unverifiable. Various conventionally understood procedures may be used in response to the receipt of an invalid command by the storage device 100 from the host 200.

With this exemplary configuration, the storage device 100 is capable of receiving various commands/instructions from the host 200. “Write data” may be received from the host 200 in relation to be write (or program) commands, and “read data” may be communicated to the host 200 in relation to read operations executed by the storage device 100.

Thus, in the illustrated embodiment of FIG. 1, the storage 100 further comprises a nonvolatile memory, such as a NAND flash memory 124 being accessed via a corresponding nonvolatile memory interface, such as flash memory interface 120, and a data buffer, such as a dynamic random access memory (DRAM) 122. In certain embodiments of the inventive concept, the DRAM 122 may comprise a double data rate synchronous dynamic random access memory (DDR SDRAM), a single data rate (SDR) SRAM, a low power (LP) DDR SDRAM, and/or a direct Rambus DRAM (RDRAM). However, physically configured, the DRAM 122 may be used as a data buffer to temporarily store incoming (from the host 200) write data to be programmed to the flash memory 124, and/or outgoing (to the host 200) read data retrieved from the flash memory 124. In certain embodiments of the inventive concept, the storage 100 may be configured as a solid state disk (SSD).

The host 200 controls the overall operation of the storage device 100 using a sequence of communicated commands, requests, instructions , and/or control signals (hereafter, singularly or collectively a “command”). Commands will typically identify various input operations (e.g., write or program operations), and various output operations (e.g., read operations). However, other commands may be used to control the execution of various housekeeping operations necessary to the proper performance of the storage device 100. In some embodiments of the inventive concept, the host 200 may be a personal computer (PC), notebook computer, tablet, server, work station, mobile device, cellular phone, smart phone, and the like. The host 200 may include a number and a variety of electronic devices and/or circuits capable of interfacing with the storage device 100.

One or more conventionally understood data communication protocols may be used by the host 200 and storage device 100 to communicate a command and/or corresponding write data from the host 200 to the storage device, or to communicate read data and/or control signal(s) from the storage device 100 to the host 200. So, in certain embodiments of the inventive concept, the host 200 and storage device 100 may use one or more of a serial advanced technology attachment (SATA) interface, peripheral component interconnect express (PCIe) interface, and the like.

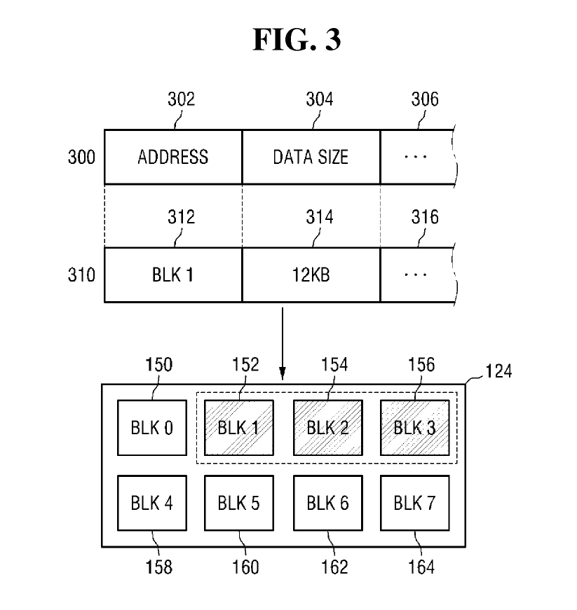

In operation, the storage device 100 uses the command parsing unit 102 to receive a command from the host 200 and may preprocess or “parse” the received command. Then the command division unit 104 may be used to divide (or selectively distributes) a parsed command received from the command parsing unit 102 into one or more “unit commands”. For example, a first unit command may be communicated by the command division unit 104 to the first data processing preparation unit 106, and a second unit command may be communicated to the second data processing preparation unit 116. In this regard, example(s) of command division unit 104 operation will be provided hereafter with reference to FIGS. 3, 4 and 5.

In the illustrated example of FIG. 1, neither the first processing unit 110 nor the second processing unit 112 is capable of “directly” writing data to or reading data from the flash memory 124. Instead, each one of the first processing unit 110 and second processing unit 112 “indirectly” writes data to and read data from the flash memory 124 by executing one or more DMA operations. That is, the first processing unit 110 and second processing unit 112 delegate write/read operation control for the flash memory 124 to the flash memory interface 120. One or more DMA operation requests from the first processing unit 110 and/or the second processing unit 112 may be used in this regard. Accordingly, the flash memory interface 120 may be used to directly control the execution of write/read operations directed to data to-be-stored in the flash memory 124 or data being retrieved from the flash memory 124 according to one or more DMA request(s). Here, the execution of one or more DMA requests may be executed by the flash memory interface 120 while the first processing unit 110 and/or second processing unit 112 execute in parallel, wholly or in part, one or more other operations. In order to request and perform certain DMA operations, the first data processing preparation unit 106 and/or second data processing preparation unit 116 may cause the execution of certain preparatory operations related to the DMA requests and/or DMA operation(s).

For example, the first data processing preparation unit 106 and/or second data processing preparation unit 116 may be used to generate one or more DMA request(s) in response to (or “based on”) one or more unit commands received from the command division unit 104. Once properly generated, the DMA request(s) may be passed to the first processing unit 110 and/or second processing unit 112.

Accordingly, assuming that the first data processing preparation unit 106 receives from the command division unit 104 one or more unit command(s) associated with a first command received from the host 200, the first data processing preparation unit 106 may be used to generate one or more first DMA request(s) based on the unit command(s) and then pass the first DMA request(s) to the first processing unit 110. Likewise, assuming that the second data processing preparation unit 116 receives from the command division unit 104 one or more unit command(s) corresponding to a second command received from the host 200, the second data processing preparation unit 116 may be used to generate one or more second DMA request(s) based on the unit command(s) and pass the second DMA request(s) to the second processing unit 112. In certain embodiments of the inventive concept, the first data processing preparation unit 106 and second data processing preparation unit 116 may be used to allocate a DMA buffer, and/or define a DMA descriptor related to one or more DMA request(s).

In this manner, the first processing unit 110 and second processing unit 112 may be used to control the execution of a specific operation(s) in the storage device 100 in response to a command received from the host 200. That is, the first processing unit 110 may be used to initiate first DMA operation(s) based on first DMA requests received from the first data processing preparation unit 106, and the second processing unit 112 may be used to initiate second DMA operation(s) based on second DMA request(s) received from the second data processing preparation unit 116. Programming code capable of defining these functions and operations may be stored as firmware, wherein the firmware may be executed by the first processing unit 110 and second processing unit 112. In some embodiments of the inventive concept, each of the first processing unit 110 and second processing unit 112 may be implemented as a semiconductor central processing unit (CPU).

In the illustrated embodiment of FIG. 1, the first processing unit 110 is “operationally associated with” (and may physically incorporated as hardware/software/firmware in the first processing unit 110) a first DMA request queue 130 capable of managing a sequence of first DMA requests received from the first data processing preparation unit 106. The first processing unit 110 is also operationally associated with (and may be physically incorporated as hardware/software/firmware in the first processing unit 110) a first DMA completion queue 140 capable of managing first DMA operation completion messages received from the first DMA interface 108 following execution DMA operations related to the first DMA requests. Likewise, the second processing unit 112 is operationally associated with (and may incorporate) a second DMA requests queue 132 capable of managing second DMA requests received from the second data processing preparation unit 116, and a second DMA completion queue 142. Here, the first DMA requests queue 130, second DMA requests queue 132, first DMA completion queue 140, and second DMA completion queue 142 may be variously implemented as one of many different conventionally understood queues, such as linear queues, circular queues, and so on.

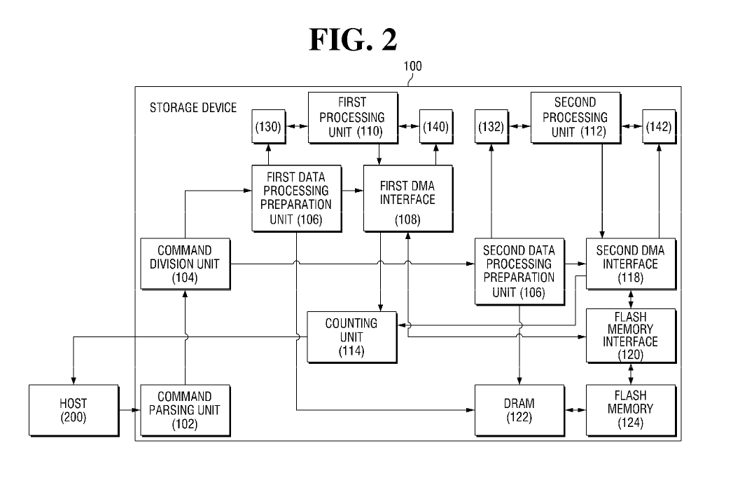

FIG. 2 is a block diagram further illustrating in one example the storage device 100 of FIG. 1.

Referring to FIGS. 1 and 2, the storage device 100 of FIG. 2 is similar in constituent nature to the storage device 100 of FIG. 1, except is further comprises a counting unit 114. The counting unit 114 may be used to determine whether or not a particular operation corresponding to a command received from the host 200 has been completed. Once the particular operation has been completed, host 200 may be notified.

For example, the counting unit 114 may be used to count a number of first DMA requests and a number of first DMA operation completion messages related to one or more first DMA operations, and alternately or additionally, the counting unit 114 may be used to count a number of second DMA requests and a number of second DMA operation completion messages related to one or more second DMA operations resulting from a particular command received from the host 200. That is, recognizing that a single command received from the host 200 may result in multiple operations being executed in relation to the flash memory 124 by the first processing unit 110 and second processing unit 112, the counting unit 114 may be used to track (or account for) the execution of the resulting multiple operations.

Upon determining that all of the first DMA operations and/or all of the second DMA operations resulting from (or “derived from”) the single command received from the host 200 have been completed, the counting unit 114 may be used to notify the host 200 by provision of a competent control signal.

FIG. 3 is a conceptual diagram illustrating in one example a command (e.g., an input command or an output command) that the host 200 may communicate to the storage device 100 of FIGS. 1 and 2.

Referring to FIG. 3, an exemplary program command 300—as an example of similar commands—communicated from the host 200 to the storage device 100 includes address information 302, data size information 304 and other information 306.

The address information 302 identifies one or more address(es) to which corresponding write data 310 will be stored. Here, the address information may indicate certain logical address(es) defined by the host 200, whereas the actual storing of the received write data by the storage device 100 occurs at physical address(es) of the flash memory 124 corresponding to the logical address(es). Various approaches and circuits capable of converting (or translating) the logical address(es) into corresponding physical address(es) are conventionally understood and will not be described herein.

As suggested by FIG. 3, the write data 310 received from the host 200 may include a number of data “blocks’ (e.g., Blk1, Blk2 . . . ) having the same or different sizes (e.g., 12 Kbytes (KB)). Here, each block may have a logical address (or logical address range) determined by the host 200 or a file system running on the host 200. When stored by the flash memory 124 in response to the command 300, each block of the received write data (Blk1, Blk2 . . . ) may be stored in one or more memory blocks (e.g., 150, 152, 154, 156, 158, 160, 162 and 164) of the flash memory 124 in relation to a corresponding physical address or range of physical addresses.

The data size information 304 may be used to indicate a size (e.g., an amount of constituent write data) associated with the entire set of write data 310, and/or sizes of various subsets of the write data (e.g., respective data block, Blk1, Blk2 . . . ). For example, the data size information 304 portion of the command 300 may include a value of “12 KB” indicating that each block of write data provided in associated with the command 300 has a size of 12 KB. Thus, assuming that each of the memory blocks 150, 152, 154, 156, 158, 160, 162 and 164 provided by the flash memory 124 of the storage device 100 has a size of 4 KB, each memory block of write data (e.g., 314) processed by the storage device 100 in response to the command 300 will require three (3) memory blocks (e.g., 152, 154 and 156) of the flash memory 124.

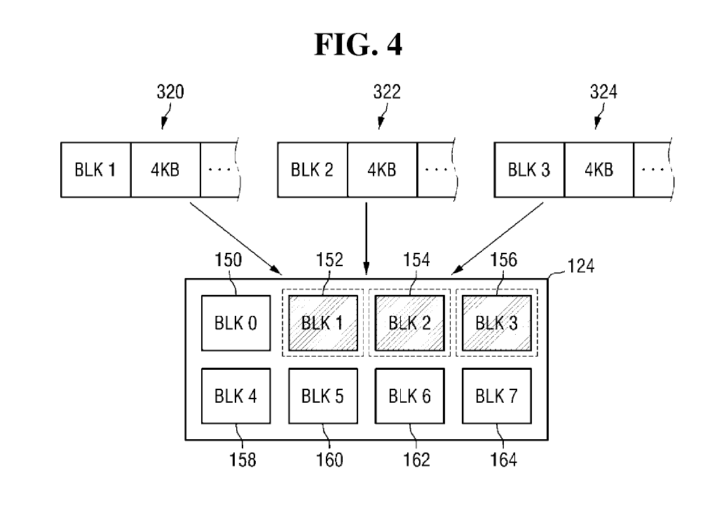

FIG. 4 is a conceptual diagram illustrating in another example a program command that the host 200 may communicate to the storage device 100 of FIGS. 1 and 2.

Referring to FIG. 4, it is assumed that the unitary (or contiguous) set of write data 310 communicated in association with the command 300 of FIG. 3 is now replaced by a plurality of (dis-contiguous) write data sets 320, 322 and 324. Alternately, three (3) different program commands may be received from the host 200 in the storage device 100, wherein each program command corresponds with one of the write data sets 320, 322 and 324.

Assuming the efficient use of a single program command 300 to program all three (3) 4KB sets of write data to the flash memory 124, the program command 300 may be divided by operation of the command division unit 140 into a plurality of unit commands (e.g., 320, 322 and 324). This “division” of a single program command may result in the re-definition of logical address(es), corresponding physical address(es), and/or data size(s) associated with the three (3) sets of write data in relation to one or more of the unit commands 320, 322 and 324. For example, in certain embodiments of the inventive concept, the command division unit 104 of the storage device 100 may define data set size(s) for each one of the respective unit commands 320, 322 and 324 in view of (e.g.,) various data storage characteristics of the flash memory 124, such as minimum program data size (e.g., 4KB or 8 KB), minimum data block size (e.g., 4KB or 8KB), etc.

In FIG. 4, assuming that each one of the sets of write data 320, 322 and 324 has a size of 4KB and further assuming program data size constraints allowing 4KB to be stored in each memory block BLK1, BLK2 and BLK3, execution of three (3) corresponding unit commands 320, 322 and 324 for each set of write data will result in programming of the respective write data sets to BLK 1, BLK 2, and BLK 3 in the flash memory 124. Thereafter, read data having a size of 4 KB may be readily retrieved from each one of memory block 152 (BLK1), 154 (BLK2) and/or 156 (BLK3) in response to one or more read commands received from host 200 and corresponding unit commands provided by the command division unit 104. Consistent with the foregoing, a plurality of unit commands (e.g., unit program commands 320, 322 and 324) may be respectively distributed to the first processing unit 106 and/or the second processing unit 116 by the command division unit 104.

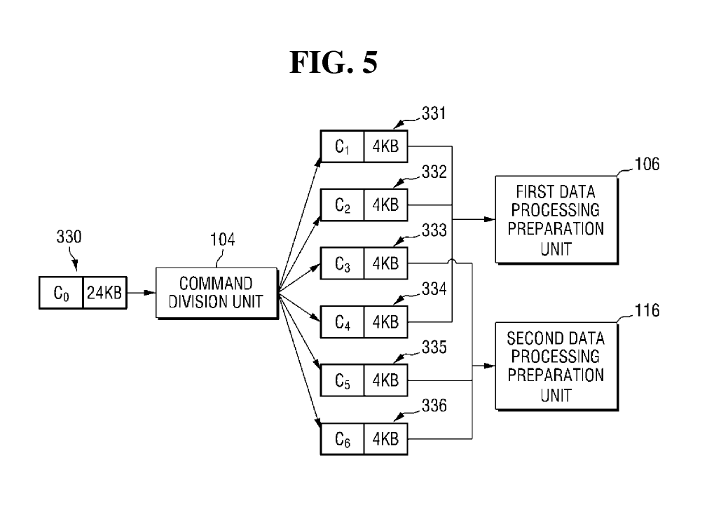

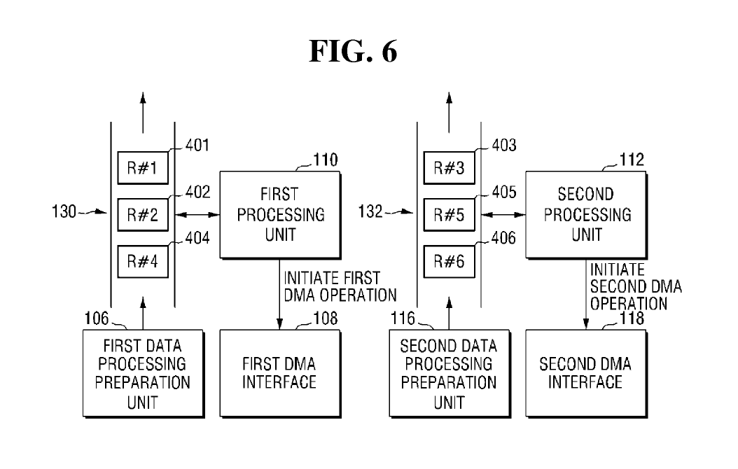

FIGS. 5 and 6 are related conceptual diagrams illustrating in one example operation of the foregoing storage device examples, including a first processing unit and a second processing unit respectively initiating appropriate DMA operations in response to a command received from the host 200.

Referring to FIGS. 1, 2 and 5, a program command 330 is divided into multiple (program) unit commands 331, 332, 333, 334, 335 and 336 by the command division unit 104. As a result, an original 24KB block of write data associated with program command 330 is divided into six (6) program unit commands 331, 332, 333, 334, 335 and 336, each one of the unit commands being respectively associated with the programming of a 4KB set of write data to the flash memory 124.

Next, certain unit commands (e.g., 331, 332 and 334) among the six (6) unit commands are distributed to the first data processing preparation unit 106 by the command division unit 104, and other unit commands (e.g., 333, 335 and 336) are distributed to the second data processing preparation unit 116 by the command division unit 104. Distribution parameters for a plurality of unit commands (e.g., 331, 332, 333, 334, 335 and 336) may be various determined in view of different storage device operating characteristics, processing loads, data storage speed requirements, etc. For example, in certain embodiments of the inventive concept, unit commands may be identified as odd or even in occurrence sequence and distributed to respective data processing preparation units as even or odd units commands, accordingly.

Referring to FIG. 6, the first data processing preparation unit 106 may then be used to generate DMA requests 401, 402 and 404 corresponding to the unit commands 331, 332 and 334, and to transmit the DMA requests 401, 402 and 404 to the first DMA request queue 130 operationally associated with the first processing unit 110. Then, the first processing unit 110 may be used to verify the first DMA request queue 130 and communicate instructions necessary to initiate corresponding DMA operation(s) to the first DMA interface 108 according to the DMA requests 401, 402 and 404 queued in the first DMA request queue 130. Then, the first DMA interface 108 may be used to interface with the flash memory interface 120 based on the DMA operations resulting from the DMA requests 401, 402 and 404 in order to execute program operation(s) in the flash memory 124 consistent with the unit commands 331, 332 and 334.

Likewise, the second data processing preparation unit 116 may be used to generate DMA requests 403, 405 and 406 corresponding to the unit commands 333, 335 and 336, and to communicate the DMA requests 403, 405 and 406 to the second DMA request queue 132 of the second processing unit 112. Then, the second processing unit 112 verifies the queued second DMA requests, and transmits a command to initiate DMA operations to the second DMA interface 108 according to the DMA requests 403, 405 and 406 to the second DMA interface 118. The second DMA interface 118 may be used to interface with the flash interface 120 based on the DMA operations according to the DMA requests 403, 405 and 406 to execute program operation(s) in the flash memory 124 according to the unit commands 333, 335 and 336.

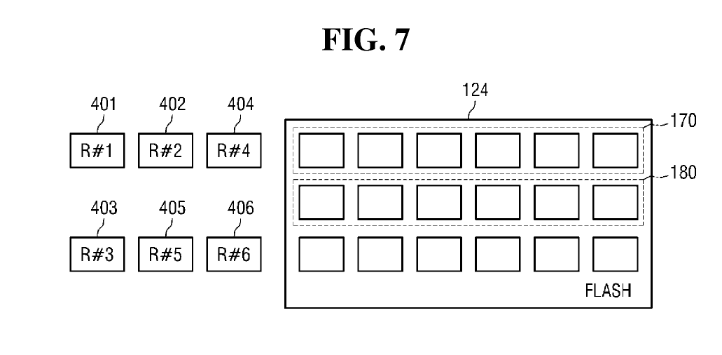

FIG. 7 is a conceptual diagram illustrating available memory areas of the flash memory 124 to which, and from which data may be programmed or read by the first processing unit 110 and the second processing unit 112 of FIGS. 1 and 2.

Referring to FIGS. 1, 2 and 7, the flash memory 124 includes multiple memory blocks, where some of the memory blocks are disposed in a first memory area 170, and others are disposed in a second memory area 180. The first memory area 170 is an area to/from which data is input/output by first DMA operations derived from the unit commands 331, 332 and 334 (e.g., DMA requests 401, 402 and 404). The second memory area 180 is an area to/from which data is input/output by second DMA operations derived from the unit commands 333, 335 and 336 (e.g., DMA requests 403, 405 and 406). As shown in FIG. 7, the first memory area 170 to/from the data is input/output by the first DMA operations processed by the first processing unit 110 and the second memory area 180 to/from the data is input/output by the second DMA operations processed by the second processing unit 112 may be completely different (without overlap) from one another.

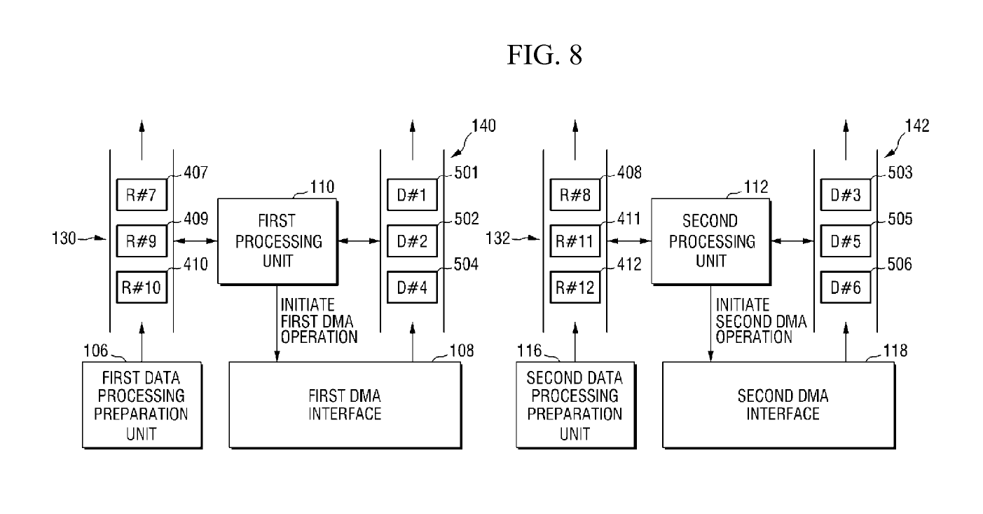

FIG. 8 is a conceptual diagram further illustrating in one example one approach whereby the first processing unit 110 and the second processing unit 112 of FIGS. 1 and 2 initiate and execute DMA operations.

Referring to FIG. 8, once the DMA operations associated with the DMA requests 401, 402 and 404 are complete, the first DMA interface 108 may communicate respective DMA operation completion messages 501, 502 and 504 to the first processing unit 110. Then, the first processing unit 110 recognizes that the corresponding DMA operations are complete in response to the DMA operation completion messages 501, 502 and 504 queued in the first DMA completion queue 140. Likewise, if the DMA operations associated with the DMA requests 403, 405 and 406 are complete, the second DMA interface 118 communicates DMA operation completion messages 503, 505 and 506 to the second processing unit 112. Then, the second processing unit 112 recognizes that the corresponding DMA operations are complete according to the DMA operation completion messages 503, 505 and 506 queued in the second DMA completion queue 142. Thus, in the illustrated first DMA requests queue 130 and second DMA requests queue 132 of FIG. 8, it is understood that new DMA requests 407, 409 and 410 are input to the first DMA requests queue 130 and new DMA requests 408, 411 and 412 are input to the second DMA requests queue 132.

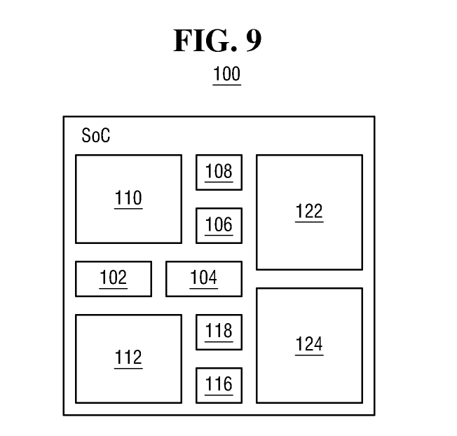

FIG. 9 is a block diagram illustrating a storage device according to certain embodiments of the inventive concept, wherein all or a material part of the storage device 100 is implemented using a System-on-Chip (SoC). Thus, as previously described, the storage device 100 comprises the command parsing unit 102, command division unit 104, first data processing preparation unit 106, first DMA interface 108, first processing unit 110, second data processing preparation unit 116, second DMA interface 118, and second processing unit 112. However, these elements are commonly implemented using a single (or unitary) SoC. In this SoC configuration, some or all of the foregoing components may be interconnected via one or more internal bus(es). These one or more bus(es) may be implemented in accordance with an AMBA Advanced eXtensible Interface (AXI) protocol, for example. In certain embodiments of the inventive concept, the SoC may be implemented using an application processor mounted on a terminal. However configured, a SoC according to an embodiment of the inventive concept will include a buffer memory (e.g., DRAM 122) and a nonvolatile memory (flash memory 124).

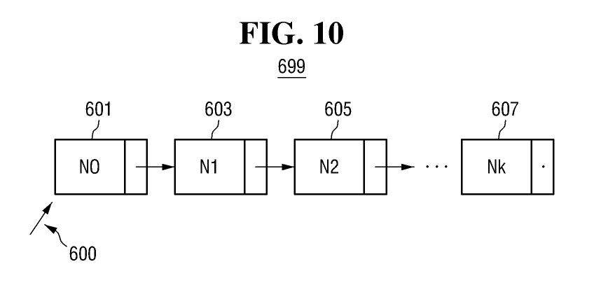

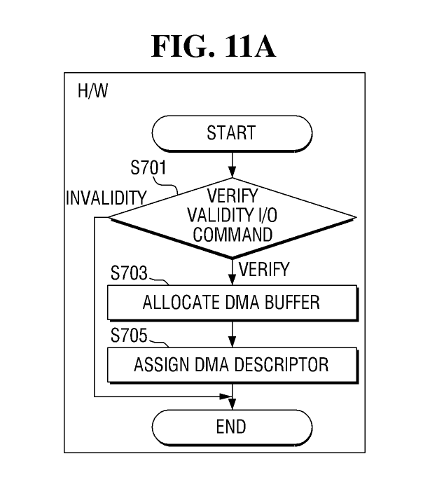

FIG. 10 is a conceptual diagram further illustrating in one example the operational use of a DMA buffer.

Referring to FIG. 10, a DMA buffer 699 required to effectively implement DMA operation(s) may be implemented in the form of a linked list data structure. In FIG. 10, the DMA buffer 699 include linked nodes 601, 603, 605 and 607 connected in a link manner and being accessible by (e.g.,) a DMA buffer pointer 600. In certain embodiments of the inventive concept, the DMA buffer 699 may be implemented as a double connection list, or a circular connection list including a bi-directional link. If implemented in these manners, the DMA buffer 699 may be easily recycled.

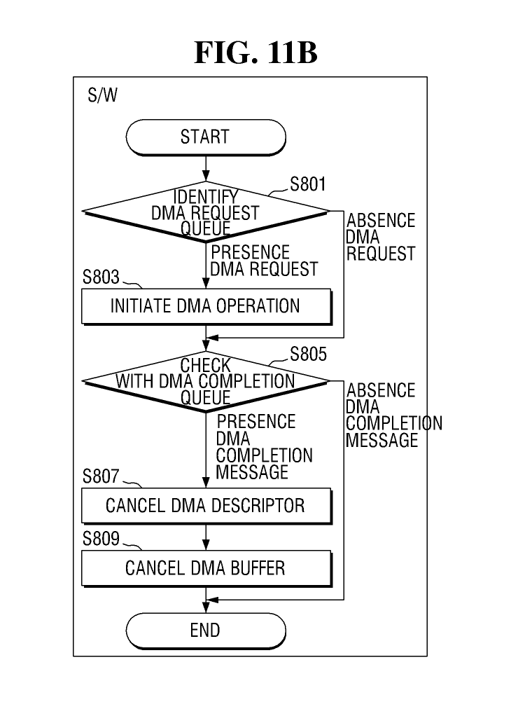

FIG. 11, inclusive of FIGS. 11A and 11B, is a flowchart illustrating a data processing method according to an embodiment of the inventive concept.

Referring to FIGS. 11A and 11B, a data processing method may be implemented in hardware and/or software (or firmware) running, wholly or in part, on the hardware. Thus, in view of the primarily hardware enabled method steps shown in FIG. 11A, the command parsing unit 102 will receive a command from the host 200 and verify the command (S701). If the command is verified, the command division unit 104 will divide the command into multiple unit commands. Then, the first data processing preparation unit 106 and/or the second data processing preparation unit 116 will cause the generated of corresponding DMA requests by allocating space in a DMA buffer (S703) and assigning a DMA descriptor (S705).

Next, in view of the primarily software enabled method steps shown in FIG. 11B, respective firmware associated with the operation of the first processing unit 110 and second processing unit 112 may be used to identify first DMA requests loaded in the first DMA request queue 130, as well as second DMA requests loaded in the second DMA request queue 132 (S801). If there are first DMA requests and/or second DMA requests, the respective firmware initiates the first DMA operations and/or second DMA operations (S803). In order to verify whether the first DMA operations and/or the second DMA operations are complete, the respective firmware checks the first DMA completion queue 140 and the second DMA completion queue 142 (S805), and if there are first DMA operation completion messages and/or second DMA operation completion messages, the DMA descriptor and the DMA buffer allocated by the first data processing preparation unit 106 and the second data processing preparation unit 116 are canceled (S807 and S809).

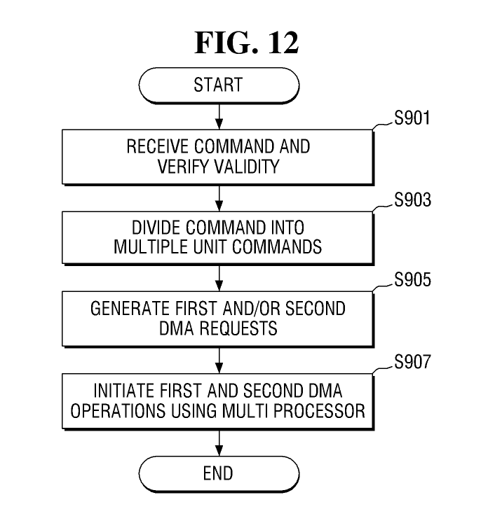

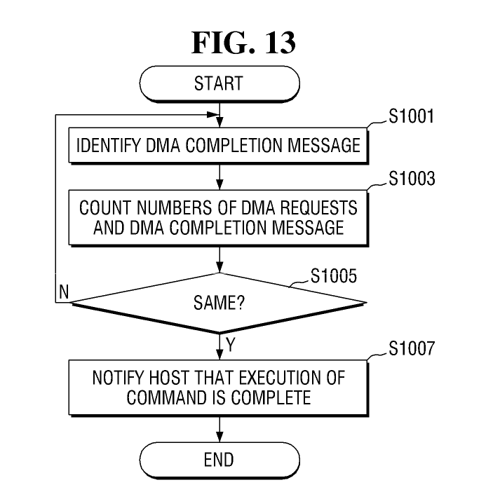

FIGS. 12 and 13 are respective flowcharts illustrating data processing methods according certain embodiments of the inventive concept.

Referring to FIGS. 1, 2 and 12, the data processing method comprises receiving a command from the host 200 in the storage device 100, and verifying the validity of the command (S901). Next, the received and verified command is divided into multiple unit commands (S903). Resulting first DMA requests are generated according to certain unit commands, while resulting second DMA requests are generated by other unit commands (S905). Thereafter, the first DMA operations and the second DMA operations respectively associated with the first DMA requests and second DMA requests are initiated using a multi-processing unit including the first processing unit 110 and the second processing unit 112 (S907).

Referring to FIG. 13, first DMA operation completion messages generated upon execution of first DMA operations, and second DMA operation completion messages generated upon execution of second DMA operations are identified (S1001). Next, a number of first DMA requests and a number of first DMA operation completion messages are counted to determine whether execution of the command has been completed (S1003). If the counts are the same (S1005=Yes), the host 200 is notified that execution of the command is complete (S1007).

According to the foregoing embodiments of the inventive concept, a host-generated command received by a storage device may be divided into multiple unit commands that are then distributed over multiple processing units, thereby processing a sequence of commands asynchronously in a pipelined manner. Therefore, it is not necessary to additionally provide a processing unit for synchronously distributing commands and serving as a locking manager.

In addition, command distribution and DMA preparation are processed using primarily hardware, thereby increasing an execution speed by reducing operation quantities of firmware executed by processing units and ultimately improving storage performance.

While the inventive concept has been particularly shown and described with reference to exemplary embodiments thereof, it will be understood by those of ordinary skill in the art that various changes in form and details may be made therein without departing from the scope of the inventive concept step as defined by the following claims. It is therefore desired that the illustrated embodiments be considered in all respects as illustrative.

What is claimed is:

1. A storage device, comprising:
a nonvolatile memory;
a command parsing unit that receives and verifies a command provided by an external host;
a command division unit that receives a verified command from the command parsing unit, divides the command into multiple unit commands, and distributes the multiple unit commands across a first processing unit and a second processing unit;
a first data processing preparation unit that receives a first set of the unit commands from the command division unit and generates corresponding first Direct Memory Access (DMA) requests;
a second data processing preparation unit that receives a second set of the unit commands from the command division unit and generates corresponding second DMA requests, wherein
the first processing unit is operationally associated with a first DMA request queue that receives and holds the first DMA requests generated by the first data processing unit, and the second processing unit is operationally associated with a second DMA request queue that receives and holds the second DMA requests generated by the second data processing unit, and
the nonvolatile memory executes a first data access operation in response to the first DMA requests, and executes a second data access operation in response to the second DMA requests.

2. The storage device of claim 1, wherein the first data processing preparation unit generates the corresponding first DMA requests by allocating space in a first DMA buffer and assigning a first DMA designator, and
the second data processing preparation unit generates the corresponding second DMA requests by allocating space in a second DMA buffer and assigning a second DMA designator.

3. The storage device of claim 1, wherein the first processing unit initiates first DMA operations according to the first DMA requests to execute the first data access operation, and the second processing unit initiates second DMA operations according to the second DMA requests to execute the second data access operation.

4. The storage device of claim 1, wherein in the nonvolatile memory comprises a first memory area to which the first data access operation is directed, and a second memory area different from the first memory area to which the second data access operation is directed.

5. The storage device of claim 1, wherein the command includes write data to be written to the nonvolatile memory and having a first size, and
the write data is divided into multiple sets of write data in accordance with the division of the verified command by the command division unit.

6. The storage device of claim 5, wherein each one of the sets of write data is uniquely and respectively associated with one of the multiple unit commands.

7. The storage device of claim 6, wherein each one of the sets of write data has a second size less than the first size.

8. The storage device of claim 7, wherein each one of the sets of write data has the same second size, and the second size is defined in view of characteristics of the nonvolatile memory.

9. The storage device of claim 8, wherein the nonvolatile memory is a flash memory and the characteristics of the flash memory include a minimum program data size and a minimum memory block size.

10. The storage device of claim 2, wherein each one of the first and second DMA buffers is implemented as a respective linked list capable of being accessed via a DMA pointer.

11. A storage device, comprising:
a nonvolatile memory;
a command parsing unit that receives and verifies a command provided by an external host;
a command division unit that receives a verified command from the command parsing unit, divides the command into multiple unit commands, and distributes the multiple unit commands across a first processing unit and a second processing unit;
a first data processing preparation unit that receives a first set of the unit commands from the command division unit and generates corresponding first Direct Memory Access (DMA) requests;
a second data processing preparation unit that receives a second set of the unit commands from the command division unit and generates corresponding second DMA requests,
wherein the first processing unit is operationally associated with a first DMA request queue that receives the first DMA requests, and is further operationally associated a first DMA completion queue that receives completion messages upon the respective completion of the first DMA requests, and the second processing unit is operationally associated with a second DMA request queue that receives the second DMA requests, and is further operationally associated a second DMA completion queue that receives completion messages upon the respective completion of the second DMA requests,
a counting unit that counts a number of the first DMA requests and a number of first DMA operation completion messages related to the first DMA operations, and counts a number of second DMA requests and a number of second DMA operation completion messages related to the second DMA operations, wherein an indication to the host that execution of the command is complete is controlled by the counting unit; and
the nonvolatile memory executes a first data access operation in response to the first DMA requests, and executes a second data access operation in response to the second DMA requests.

12. The storage device of claim 11, wherein upon determining that the counted number of the first DMA requests and the counted number of first DMA operation completion messages are the same, and
upon determining that the counted number of the second DMA requests and the counted number of second DMA operation completion messages are the same,
the counting unit provides a control signal to the host indicating completion of the command.

13. The storage device of claim 11, wherein the first data processing preparation unit generates the corresponding first DMA requests by allocating space in a first DMA buffer and assigning a first DMA designator, and
the second data processing preparation unit generates the corresponding second DMA requests by allocating space in a second DMA buffer and assigning a second DMA designator.

14. The storage device of claim 11, wherein the first processing unit initiates first DMA operations according to the first DMA requests to execute the first data access operation, and the second processing unit initiates second DMA operations according to the second DMA requests to execute the second data access operation.

15. The storage device of claim 11, wherein in the nonvolatile memory comprises a first memory area to which the first data access operation is directed, and a second memory area different from the first memory area to which the second data access operation is directed.

16. The storage device of claim 11, wherein the command includes write data to be written to the nonvolatile memory and having a first size,
the write data is divided into multiple sets of write data in accordance with the division of the verified command by the command division unit,
each one of the sets of write data is uniquely and respectively associated with one of the multiple unit commands, and
each one of the sets of write data has a same second size less than the first size.

17. A method of operating a storage device including a first processing unit and a second processing unit each storing data in a flash memory, the storage device receiving a command from a host, and the method, comprising:
receiving and verifying the command;
upon verifying the command, dividing the command into multiple unit commands;
distributing the multiple unit commands across the first and second processing units;
generating first Direct Memory Access (DMA) requests in response to a first set of the unit commands, and generating second DMA requests in response to a second set of the unit commands;
queuing the first DMA requests for access by the first data processing unit, and queuing the second DMA request for access by the second processing unit; and
executing a first data access operation in the flash memory in response to the first DMA requests, and executing a second data access in the flash memory in response to the second DMA requests.

18. The method of claim 17, wherein generating the first DMA requests includes allocating space in a first DMA buffer and assigning a first DMA designator, and the generating of the second DMA requests includes allocating space in a second DMA buffer and assigning a second DMA designator.

19. The method of claim 17, wherein the first processing unit initiates first DMA operations according to the first DMA requests to execute the first data access operation, and the second processing unit initiates second DMA operations according to the second DMA requests to execute the second data access operation.

20. The method of claim 17, wherein in the nonvolatile memory comprises a first memory area to which the first data access operation is directed, and a second memory area different from the first memory area to which the second data access operation is directed.
